(19) United States
(12) Patent Application Publication
(10) Pub. No.: US 2002/0078096 A1
(43) Pub. Date: Jun. 20, 2002

(54) System and method for pruning an article

(76) Inventor: John R. Milton, Corvallis, OR (US)

Correspondence Address: HEWLETT-PACKARD COMPANY, Intellectual Property Administration, P.O. Box 272400, Fort Collins, CO, 80527-2400, US

(21) Appl. No.: 09/738,208

(22) Filed: Dec. 15, 2000

(51) Int. Cl. G06F 17/27

(52) U.S. Cl. 707/517; 707/511

(57) ABSTRACT

A system and a method are provided for pruning an article to fit in an allocated space of a publication. In one embodiment, the system includes a processor circuit having a processor and a memory with article pruning logic stored on the memory and executable by the processor. The article pruning logic comprises logic to automatically reduce a length of an original article to fit within a predefined space allocation of a publication. This may be accomplished by executing logic to create a pruning copy of the original article to be reduced, logic to remove an amount of content from the pruning copy, and logic to compare a pruned content of the pruning copy with a content of the original article to determine an informational adequacy of the pruned content.

### TECHNICAL FIELD

The present invention is generally related to the field of generating publications and, more particularly, is related to a system and method for pruning an article to be placed in a publication.

### BACKGROUND OF THE INVENTION

In the publication business, it is often the case that articles are written so as to accommodate future editing. Such articles are written by authors for inclusion in various publications such as, for example, newspapers, magazines, on-line publications and other media. These articles may need editing for a variety of reasons, including spelling errors, grammatical errors, or simply altering statements that a particular publication is unwilling to make due to potential liability. Another common reason why articles may be edited is because they do not fit into the allocated space for the article. Specifically, editors often layout a publication giving priority to various articles and advertisements. Many times this practice may leave less space than is needed for an article of lesser priority. Thus, authors have employed various mechanisms to allow their articles to be shortened to fit within an allocated space without a major loss of substance.

One such mechanism is called the “inverted pyramid style” of writing. In the inverted pyramid style of writing, the first paragraph or two of a story summarizes or otherwise outlines all or most of the important information about a story. The end or outcome of the story is told immediately at the beginning with no major ideas held back. Thereafter, detail that supports the information in the leading paragraphs is added in decreasing order of importance. Preferably, each subsequent paragraph discusses a specific detail or fact, although more than one detail may be discussed as necessary. If such a story is cut to fit within an allocated space, it is cut from the bottom up. This ensures that the most essential information in the article is retained.

In some cases, however, this technique may not always work. Specifically, in many cases, the lesser details in subsequent paragraphs may still be important such that the substance of an article is undermined if the paragraph is deleted. Also, the process of cutting an article and ensuring that adequate substance is retained is time consuming and expensive since specialized personnel are often employed for such tasks.

### SUMMARY OF THE INVENTION

In light of the forgoing, the present invention provides for a system and a method for pruning an article to fit in an allocated space of a publication. In one embodiment, the system includes a processor circuit having a processor and a memory with article pruning logic stored on the memory and executable by the processor. The article pruning logic comprises logic to automatically reduce the length of an original article to fit within a predefined space allocation of a publication. This may be accomplished, for example, by executing logic to create a pruning copy of the original article to be reduced, logic to remove an amount of content from the pruning copy, and logic to compare the pruned content of the pruning copy with the content of the original article to determine an informational adequacy of the pruned content.

The present invention may also be viewed as a method for pruning an article, comprising the step of automatically reducing the length of an original article in a computer system to fit within a predefined space allocation of a publication. This step may further include the steps of: storing the original article in a memory of the computer system, creating a pruning copy of the original article to be reduced, storing the pruning copy in the memory, removing an amount of content from the pruning copy, and comparing the pruned content of the pruning copy with the content of the original article to determine an informational adequacy of the pruned content.

The present invention is advantageous in that is provides an automated means for pruning an article to fit in an allocated space in a publication, thereby reducing the cost necessary to generate the publication.

Other features and advantages of the present invention will become apparent to a person with ordinary skill in the art in view of the following drawings and detailed description. It is intended that all such additional features and advantages be included herein within the scope of the present invention.

### BRIEF DESCRIPTION OF THE SEVERAL VIEWS OF THE DRAWINGS

The invention can be understood with reference to the following drawings. The components in the drawings are not necessarily to scale. Also, in the drawings, like reference numerals designate corresponding parts throughout the several views.

FIG. 1 is a block diagram of a network that includes a document processing system according to the present invention;

FIG. 2 is a functional block diagram depicting the operation of the document processing system of FIG. 1; and

FIG. 3 is a flow chart of article pruning logic that is executed in the document processing system of FIG. 1.

### DETAILED DESCRIPTION OF THE INVENTION

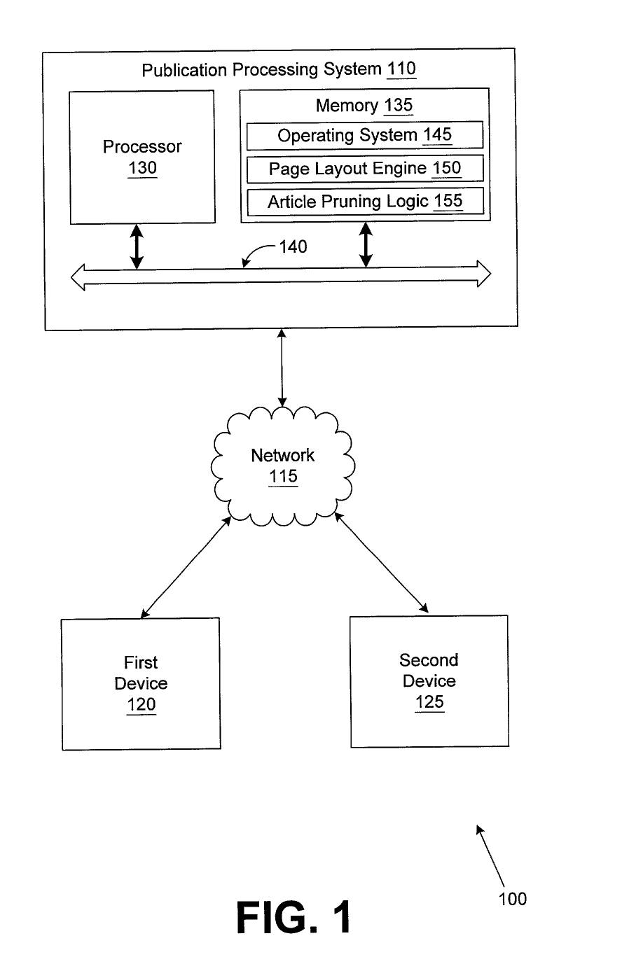

With reference to FIG. 1, shown is a block diagram of a publication network 100 that includes a publication processing system 110 according to an aspect of the present invention. In addition to the publication processing system 110, the publication network 100 also includes a network 115, a first device 120, and a second device 125. The network 100 may also include other devices and/or network elements, etc., not shown in FIG. 1. In one embodiment, the publication processing system 110 features a processor circuit that includes processor 130 and a memory 135, both of which are coupled to a local interface 140. The local interface 140 may be, for example, a data bus with an accompanying control bus, etc. The document processing system 110 may also be, for example, a server, client, or other network element that is coupled to the network 115.

Stored on the memory 135 and executable by the processor 130 is an operating system 145, a page layout engine 150, and article pruning logic 155. The page layout engine 150 is executed by the processor 130 to lay out articles, images, and other content items to create a publication to be presented to a user via a particular medium. The medium may be, for example, a paper document such as a newspaper or magazine, a digital document viewed on a display device, or other medium. To lay out a publication, the page layout engine 150 matches content items with various space allocations on the publication. The content items may be received, for example, through the network 115 from the first or second device 120 or 125, or from some other network element as will be discussed. Also, the content items may be obtained from a database, for example, that is stored in the memory 135. In cases where the content item is a text article, sometimes the space allocation on the publication may not be large enough to accommodate all of the text of the article. Consequently, the publication processing system includes the article pruning logic 155 that automatically shortens such articles as needed as will be discussed.

The network 115 may be, for example, the Internet, wide area networks (WANs), local area networks, or other suitable networks, etc., or any combination of the two or more such networks. The publication processing system 110 is coupled to the network 115 to facilitate data communication to and from the network 115 in any one of a number of ways that are generally known by those of ordinary skill in the art. In particular, the publication processing system 110 may be linked to the network 115 through various devices such as, for example, network cards, modems, or other such communications devices. Also, the publication processing system 110 may be coupled to the network 115 through a local area network and an appropriate network gateway or other arrangements, etc.

With regard to the publication processing system 110, the memory 135 may include both volatile and nonvolatile memory components. Volatile components are those that do not retain data values upon loss of power. Nonvolatile components are those that retain data upon a loss of power. Thus, the memory 135 may comprise, for example, random access memory (RAM), read-only memory (ROM), hard disk drives, floppy disks accessed via an associated floppy disk drive, compact disks accessed via a compact disk drive, magnetic tapes accessed via an appropriate tape drive, and/or other memory components, or a combination of any two or more of these memory components.

In addition, the processor 130 may represent multiple processors and the memory 135 may represent multiple memories that operate in parallel. In such a case, the local interface 140 may be an appropriate network that facilitates communication between any two of the multiple processors or between any processor and any of the memories, etc. The local interface 140 may facilitate memory to memory communication as well. The processor 130, memory 135, and local interface 140 may be electrical or optical in nature. Also, the memory 135 may be magnetic in nature.

The publication processing system 110 may also include various input/output devices that are known by those with ordinary skill in the art. In particular, user input devices may include, for example, a keypad, touch pad, touch screen, microphone, scanner, mouse, joystick, or one or more push buttons, etc. User output devices may include display devices, indicator lights, speakers, printers, etc. Specific display devices may be, for example, cathode ray tubes (CRT), a liquid crystal display screens, a gas plasma-based flat panel displays, light emitting diodes, etc.

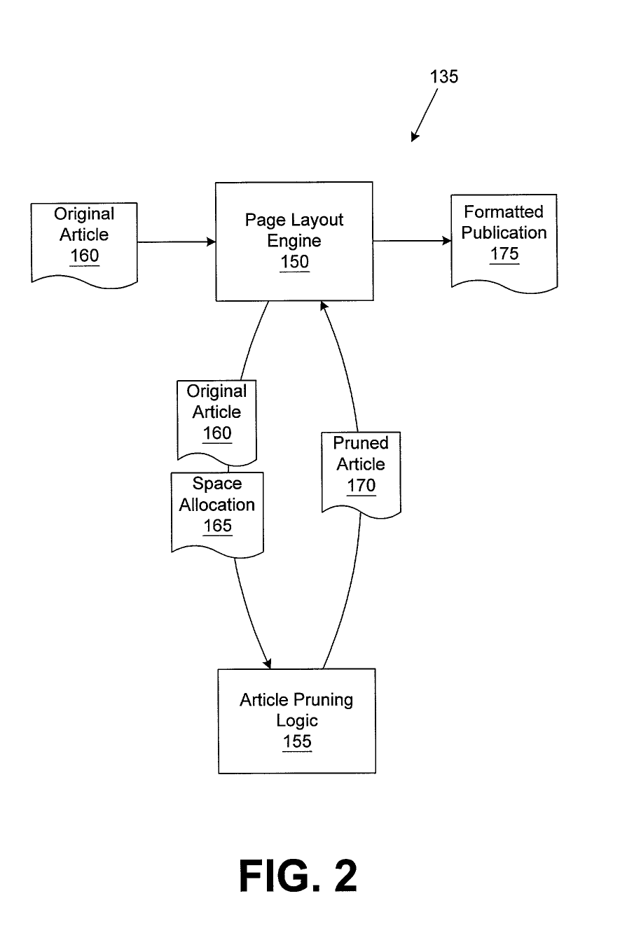

With reference to FIG. 2, shown is a functional block diagram of the page layout engine 150 and the article pruning logic 155 that are stored on the memory 135 according to an embodiment of the present invention. As shown in FIG. 2, each block represents a module, object, or other grouping or encapsulation of underlying functionality as implemented in programming code. However, the same underlying functionality may exist in one or more modules, objects, or other groupings or encapsulations that differ from those shown in FIG. 2 without departing from the present invention as defined by the appended claims.

To begin, an original article 160 is applied to the page layout engine 150 to be included in a particular publication generated by the page layout engine 150. The original article 160 may be, for example, a text file of an article written by an author presumably in the inverted pyramid style. The original article 160 may be obtained from a server via the network 115 (FIG. 1) or it may actually reside on the memory 135 (FIG. 1). For example, the original article 160 may be stored in a database on the memory 135. Alternatively, the page layout engine 150 may request the original article 160 from a specified uniform resource locator (URL) via the network 115 or a server may simply transmit the original article 160 to the page layout engine 150. How ever the original article 160 is obtained, the page layout engine 150 then attempts to fit the original article 160 into an appropriate space allocation of a publication to be created and transmitted to a final user in some form. However, in some cases the original article 160 may not fit in the space allocation of the publication in question. If such is the case, then the page layout engine 150 supplies the original article 160 and the space allocation 165 to the article pruning logic 155 as shown.

Upon receiving the original article 160 and the space allocation 165, the article pruning logic 155 attempts to reduce the size of the original article 160 to fit the space allocation 165 while at the same time retaining the substance of the original article 160 above a predetermined threshold. Assuming that the original article 160 can be reduced in length to fit the space allocation 165 without compromising its content, then the article pruning logic 155 ultimately generates a pruned article 170 that is a reduced version of the original article 160. Thereafter, article pruning logic 155 supplies the pruned article 170 to the page layout engine 150 to be included in the publication. Ultimately, the page layout engine 150 generates a formatted publication 175 in either a paper or digital format that is presented to the user accordingly.

Note that as an alternative, the article pruning logic 155 may only receive the original article 160 and not the space allocation 165. In this regard, the functionality of comparing the pruned article 170 to the space allocation 165 is performed in the page layout engine 150. In a similar manner, the functionality of the article pruning logic 155 may be partially or wholly included within the page layout engine 150, where the configuration as shown with reference to FIG. 2 merely provides an example to facilitate discussion of the present invention.

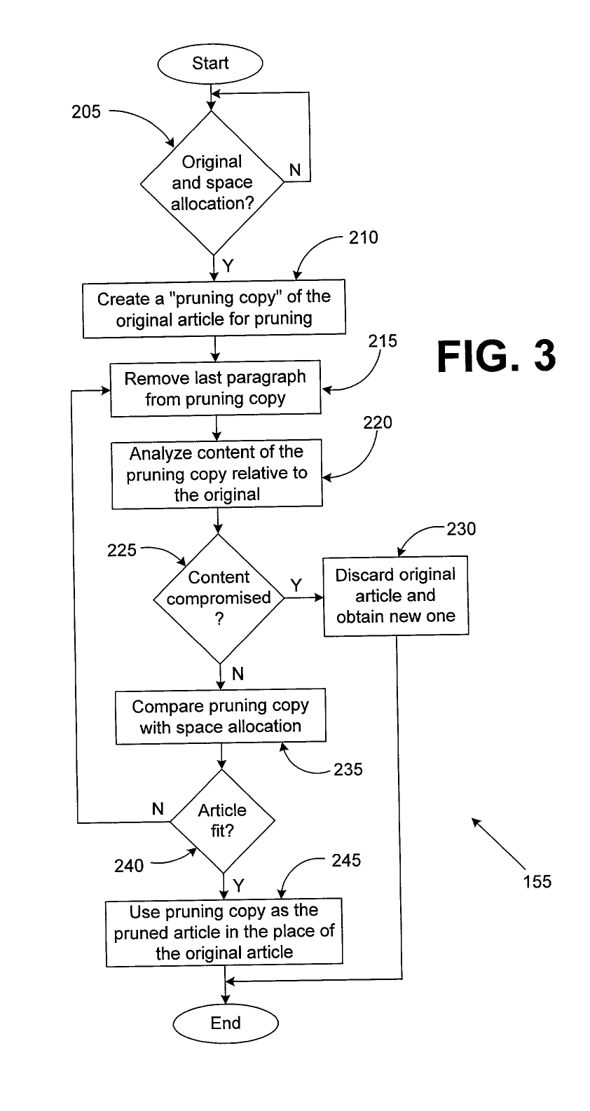

With reference to FIG. 3, shown is a flow chart of the article pruning logic 155 according to an embodiment of the present invention. Alternatively, the flow chart of FIG. 3 may be viewed as steps in a method to prune the original article 160 (FIG. 2) to fit into the space allocation 165 (FIG. 2). The article pruning logic 155 is executed to shorten an original article 160 that does not fit within a particular space allocation 165 as discussed previously. Beginning with block 205, the article pruning logic 155 remains in an idle state until an original article 160 and a space allocation 165 are received from the page layout engine 150 (FIG. 2). The space allocation 165 may include, for example, a size of the region that is to accommodate the article in question.

Upon receiving both items, the article pruning logic 155 moves to block 210 in which a “pruning copy” is made of the original article 160 and stored in the memory 135 (FIG. 1). The pruning copy is a copy of the original article 160 that is to be reduced in length. The pruning copy is created so that the original article 160 can be maintained in its original form. The original article 160 and the space allocation 165 are also stored in the memory 135 for future use.

Thereafter, the article pruning logic 155 moves to block 215 in which the last paragraph is removed from the pruning copy stored in the memory 135. This is done to shorten the pruning copy so that it may fit within the space allocation 165. Note the last paragraph is removed as it is assumed that the original article 160 has been written using the inverted pyramid style where the last paragraph is deemed the least important in terms of content.

The article pruning logic 155 then moves to block 220 in which the content of the pruning copy is analyzed relative to the content of the original article 160. This is done to facilitate a measurement of the remaining content of the pruning copy relative to the original article 160 to determine whether the removal of the last paragraph of the pruning copy in block 215 has compromised its content. In other words, the analysis is performed to determine informational adequacy of the pruning copy relative to the information contained in the original article 160.

There are a number of approaches that may be employed to determine whether the content of the pruning copy in its current shortened state has been compromised by the reduction in its length. One such approach involves the use of so called “clustering tools”. Clustering tools are often employed, for example, to find smaller groups of articles among a larger number of articles that have similar content. Clustering tools involve the execution of various algorithms to find similarity in the content of two or more documents. Such tools have been employed, for example, to provide an overview of the content of a large document collection or to improve the browsing process.

In the context of the present invention, a clustering tool may be employed to compare the content of the pruning copy with the content of the original article 160. If the pruning copy and the original article 160 still “cluster” after the analysis is complete, then it is deemed that the content of the pruning copy has not been compromised by the reduction in length. Thus, according to one aspect of the present invention, clustering may be employed to determine whether the content of the pruning copy has not been compromised as compared with the content of the original article 160.

In another example, a different approach would be to analyze the content of both the pruning copy and the original article 160 to obtain a first value reflecting the nature of the content of the original article 160 and a second value reflecting the nature of the content of the pruning copy. This may be done, for example, by averaging the number of occurrences of key terms or of all uncommon terms beyond words like “the” or “and”. The second value may be divided by the first value to obtain a ratio that states the quality of the content of the pruning copy as compared to the original copy 160. This ratio can be used as a metric to be compared to a predefined threshold to determine whether the content of the pruning copy has been compromised due to the reduction in length. Alternatively, the actual number of times common important words are used may be employed to determine the ratio as opposed to a statistical average of use.

Yet another approach would be to measure the relative frequency of use of important terms relative to the total number of words in the article. According to this approach, first, important or uncommon terms are identified in the original article 160 and in the pruning copy. Next, the frequency of use of these terms relative to the total number of words is determined for both the original article 160 and the pruning copy. The frequency of use of the terms in each provides a metric by which the content of the pruning copy may be evaluated. Specifically, if the frequency of use of any term or select terms in the pruning copy dips below a predetermined threshold, then the content of the pruning copy is deemed compromised. This ensures that the content of the pruning copy is uniform and not skewed after the reduction in length.

In addition, a parallel analysis may be performed in which two or more of the above approaches are employed simultaneously to determine the content of the pruning copy has been compromised.

Next, in block 225, if the content of the pruning copy has been compromised relative to the content of the original article 160, then the article pruning logic 155 moves to block 230. In block 230, the original article 160 is discarded and a new original article 160 is obtained for the allocated space in the publication that is currently being created in the page layout engine 150 (FIG. 2). This is because the current original article 160 cannot be fit into the space allocation 165 without compromising its content. In discarding the original article 160, the article pruning logic 155 may transmit a message to the page layout engine 150 that the current original article 160 cannot be used. The page layout engine 150 may respond thereafter by discarding the original article 160 and obtaining a new one to start the process anew. After block 230, the article pruning logic 155 ends as shown.

Referring back to block 225, if the removal of the last paragraph of the pruning copy has not compromised the content contained therein, then the article pruning logic 155 moves to block 235 in which the pruning copy in its current state is compared to the space allocation to determine whether it fits. Next, in block 240, if the pruning copy has been shortened to the extent that it fits in the space allocation 165, then the article pruning logic 155 moves to block 245 in which the pruning copy is used in the place of the original article 160 in the space allocation by the page layout engine 150. Specifically, the article pruning logic 155 ensures that the pruning copy is used by supplying the pruning copy as the pruned article 170 (FIG. 2) to the page layout 150 to insert into the space allocation of the publication. Thereafter, the article pruning logic 155 ends. Referring back to block 240, if the pruning copy does not fit into the space allocation 165, then the article pruning logic 155 reverts back to block 215 in which the last paragraph of the pruning copy in its current state is removed to repeat the process once more.

Although the logic 155 (FIG. 3) of the present invention is embodied in software as discussed above, as an alternative the 155 may also be embodied in hardware or a combination of software and hardware. If embodied in hardware, the 155 can be implemented as a circuit or state machine that employs any one of or a combination of a number of technologies. These technologies may include, but are not limited to, discrete logic circuits having logic gates for implementing various logic functions upon an application of one or more data signals, application specific integrated circuits having appropriate logic gates, programmable gate arrays (PGA), field programmable gate arrays (FPGA), or other components, etc. Such technologies are generally well known by those skilled in the art and, consequently, are not described in detail herein.

The flow chart of FIG. 3 shows the architecture, functionality, and operation of an implementation of the logic 155. If embodied in software, each block may represent a module, segment, or portion of code that comprises one or more executable instructions to implement the specified logical function(s). If embodied in hardware, each block may represent a circuit or a number of interconnected circuits to implement the specified logical function(s). Although the flow chart of FIG. 3 shows a specific order of execution, it is understood that the order of execution may differ from that which is depicted. For example, the order of execution of two or more blocks may be scrambled relative to the order shown. Also, two or more blocks shown in succession in FIG. 3 may be executed concurrently or with partial concurrence. It is understood that all such variations are within the scope of the present invention.

Also, the logic 155 can be embodied in any computer-readable medium for use by or in connection with an instruction execution system such as a computer/processor based system or other system that can fetch or obtain the logic from the computer-readable medium and execute the instructions contained therein. In the context of this document, a “computer-readable medium” can be any medium that can contain, store, or maintain the logic 155 for use by or in connection with the instruction execution system. The computer readable medium can comprise any one of many physical media such as, for example, electronic, magnetic, optical, electromagnetic, infrared, or semiconductor media. More specific examples of a suitable computer-readable medium would include, but are not limited to, a portable magnetic computer diskette such as floppy diskettes or hard drives, a random access memory (RAM), a read-only memory (ROM), an erasable programmable read-only memory, or a portable compact disc.

Although the invention is shown and described with respect to certain preferred embodiments, it is obvious that equivalents and modifications will occur to others skilled in the art upon the reading and understanding of the specification. The present invention includes all such equivalents and modifications, and is limited only by the scope of the claims.

I/We claim:

1. A system for pruning an article, comprising:
a processor circuit having a processor and a memory; and
article pruning logic stored on the memory and executable by the processor, the article pruning logic comprising logic to automatically reduce a length of an original article to fit within a predefined space allocation of a publication.

2. The system of claim 1, wherein the logic to automatically reduce the length of the original article further comprises:
logic to create a pruning copy of the original article to be reduced;
logic to remove an amount of content from the pruning copy; and
logic to compare a pruned content of the pruning copy with a content of the original article to determine an informational adequacy of the pruned content.

3. The system of claim 2, wherein the logic to remove an amount of content from the pruning copy further comprises logic to remove a last paragraph of the pruning copy.

4. The system of claim 2, wherein the logic to compare a pruned content of the pruning copy with a content of the original article to determine an informational adequacy of the pruned content further comprises:
logic to obtain a first value measuring the content of the original article by performing an analysis of the content of the original article;
logic to obtain a second value measuring the content of the pruning copy by performing an analysis of the content of the pruning copy; and
logic to compare a ratio of the first value to the second value to a predefined threshold ratio.

5. The system of claim 2, wherein the logic to automatically reduce the length of the original article further comprises logic to discard the original article and the pruned copy if the informational adequacy of the pruned content is insufficient to publish.

6. The system of claim 2, wherein the logic to automatically reduce the length of the original article further comprises logic to include the pruned copy in a publication if the informational adequacy of the pruned content is sufficient to publish.

7. A system for pruning an article, comprising:
means for creating a pruning copy of the original article to be reduced;
means for removing an amount of content from the pruning copy; and
means for comparing a pruned content of the pruning copy with a content of the original article to determine an informational adequacy of the pruned content.

8. The system of claim 7, wherein the means for removing an amount of content from the pruning copy further comprises means for removing a last paragraph of the pruning copy.

9. The system of claim 7, wherein the means for comparing a pruned content of the pruning copy with a content of the original article to determine an informational adequacy of the pruned content further comprises:
means for obtaining a first value measuring the content of the original article by performing an analysis of the content of the original article;
means for obtaining a second value measuring the content of the pruning copy by performing an analysis of the content of the pruning copy; and
means for comparing a ratio of the first value to the second value to a predefined threshold ratio.

10. The system of claim 7, wherein the means for automatically reducing the length of the original article further comprises means for discarding the original article and the pruned copy if the informational adequacy of the pruned content is insufficient to publish.

11. The system of claim 7, wherein the means for automatically reducing the length of the original article further comprises means for including the pruned copy in a publication if the informational adequacy of the pruned content is sufficient to publish.

12. A method for pruning an article, comprising the step of:
automatically reducing a length of an original article in a computer system to fit within a predefined space allocation of a publication.

13. The method of claim 12, wherein the step of automatically reducing the length of the original article in a computer system further comprises the steps of:
storing the original article in a memory of the computer system;
creating a pruning copy of the original article to be reduced;
storing the pruning copy in the memory;
removing an amount of content from the pruning copy; and
comparing a pruned content of the pruning copy with a content of the original article to determine an informational adequacy of the pruned content.

14. The method of claim 13, wherein the step of removing an amount of content from the pruning copy further comprises the step of removing a last paragraph of the pruning copy.

15. The method of claim 13, wherein the step of comparing a pruned content of the pruning copy with a content of the original article to determine an informational adequacy of the pruned content further comprises the steps of:
obtaining a first value measuring the content of the original article by performing an analysis of the content of the original article;
obtaining a second value measuring the content of the pruning copy by performing an analysis of the content of the pruning copy; and
comparing a ratio of the first value to the second value to a predefined threshold ratio.

16. The method of claim 13, wherein the step of automatically reducing the length of the original article in a computer system further comprises the step of discarding the original article and the pruned copy if the informational adequacy of the pruned content is insufficient to publish.

17. The method of claim 13, wherein the step of automatically reducing the length of the original article further comprises the step of including the pruned copy in a publication if the informational adequacy of the pruned content is sufficient to publish.
